(19) United States
(12) Patent Application Publication
(10) Pub. No.: US 2008/0222959 A1
(43) Pub. Date: Sep. 18, 2008

(54) Height Adjustment Mechanism for Window Mountings, Shutters or the Like

(75) Inventor: Torbjorn Blomqvist, Lammhult (SE)

Correspondence Address: DAVIS BUJOLD & Daniels, P.L.L.C., 112 PLEASANT STREET, CONCORD, NH, 03301, US

(73) Assignee: STEELFORM SCANDINAVIA AB, Lammhult (SE)

(21) Appl. No.: 11/994,682

(22) PCT Filed: Jul. 6, 2006
(86) PCT No.: PCT/SE2006/000843

§ 371 Date: Jan. 4, 2008

(30) Foreign Application Priority Data
Aug. 3, 2005 (SE) 0501762-9

(51) Int. Cl. E05D 15/44

(52) U.S. Cl. 49/252

(57) ABSTRACT

The present invention relates to a device, designed for a height adjustment of a window, shutter or the like. The invention has made it possible to carry out this adjustment using a device, which can be mounted in a factory or at a later occasion, e.g. by the final customer. The height adjustment is carried out by means of an eccentric (8), which is positioned in a space (16) for the eccentric in a window frame (12), the eccentric being pressed and retained against the frame (2) by means of a fastening plate (5). By loosening the screws (18), which hold the fastening plate (5) a height adjustment can be carried out. The eccentric (8) is designed to receive a key, by which the eccentric can be rotated and in this way accomplish the height adjustment.

The present invention relates to a device for a height adjustment of a window in connection with or after a mounting of the window in the window frame.

This type of device is designed to enable a height adjustment of the mountings, which hold the casement in the window frame and which at the same time enables a turning of the window in relation to the frame.

The adjustment possibility can be used to afterwards easily adjust the height position of the casement and its inclination in relation to the frame. This possibility to an adjustment is necessary partly for eliminating the manufacturing tolerances, which always exist for the various details or the fastening mountings and for the frame and window casement parts respectively and in this way obtain en optimal fit between the casement and the frame, and partly for fastening defaults as to the window in the wall.

There are solutions to the fastening problem in the patent literature, but these solutions normally are based on a cooperation of a number of expensive construction details in order to obtain the required function. One method of solving the fit problem is described in DE 37 38 596 A1. Another is described in U.S. Pat. No. 4,790,106.

These solutions have that in common, that partly a number of details must be used to obtain the function and partly the details must be mounted in a factory or in connection with the mounting of the window frame and that the various details in the starting position, i.e. during the manufacture, always are designed in such a way, that the adjustment work can be done. Thus, these constructions require, that an adjustment operation always will be carried out. However, this is not always the case. In certain cases the adjustment operation is necessary, but in other cases it is not necessary.

The drawbacks of earlier constructions are primarily their complicated production. The older solutions are normally based on an assumption already in the planning stage, that an adjustment possibility is required in order to obtain a satisfactory function in the mounted window section. This means, that there are logistic drawbacks inherent in an O-flexible solution. Already when the order has been obtained, a capacity has been locked up and times and alterations in the planning stage always mean higher costs.

The present invention is simple, which means, that it is always possible in the production to obtain mountings, which maintain the casement in the frame, in the same design, regardless of whether these mountings will be used in combination with the height and position adjustment mechanism or not. Thanks to the construction design it is also possible to mount the matching eccentric on the mountings automatically in a mounting machine, designed for this purpose, when the mountings are manufactured, or the eccentric may be sold separately and be mounted by the window manufacturer or by the final customer. The present invention also has the advantage, that no extra details are ever required in order to carry out the height adjustment of the window casement except the eccentric itself. As an example can be mentioned, that no extra screws are necessary or other fixing elements to retain or fix the eccentric, but the screws, which are used to mount the window casement against the frame, are the only screws, which are needed to fix the eccentric.

Additional characterizing features and advantages of the present invention are set forth in the following description, reference being made to the enclosed drawings. The drawings show a few preferred but not limiting embodiments. The drawings show in detail:

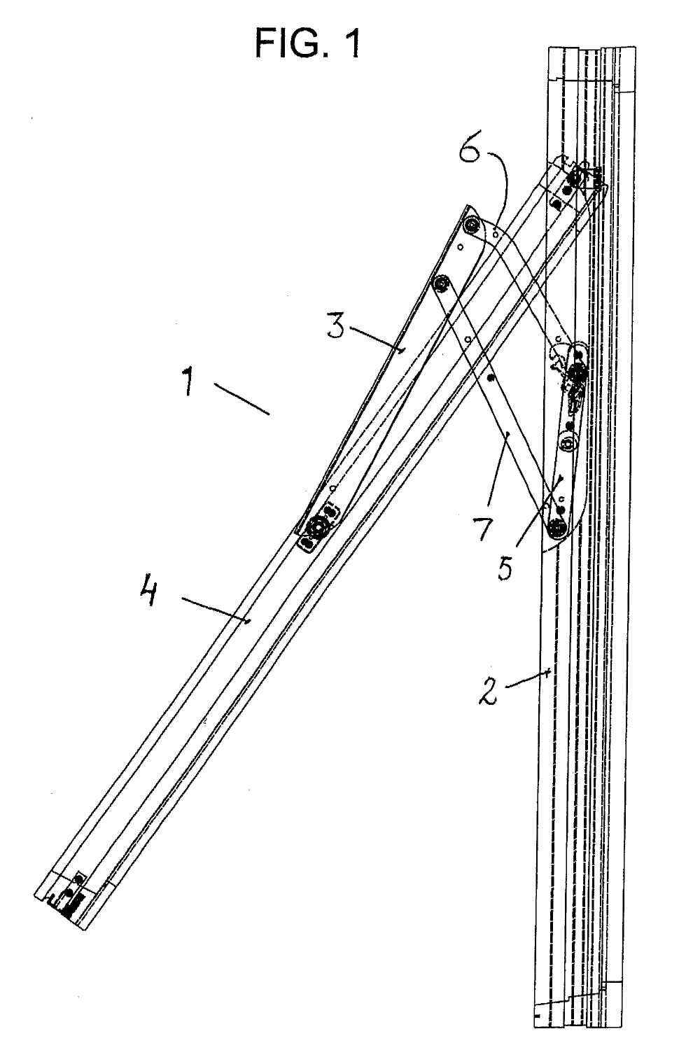

FIG. 1 the entire window frame with the window casement, the latter in a detached opening position;

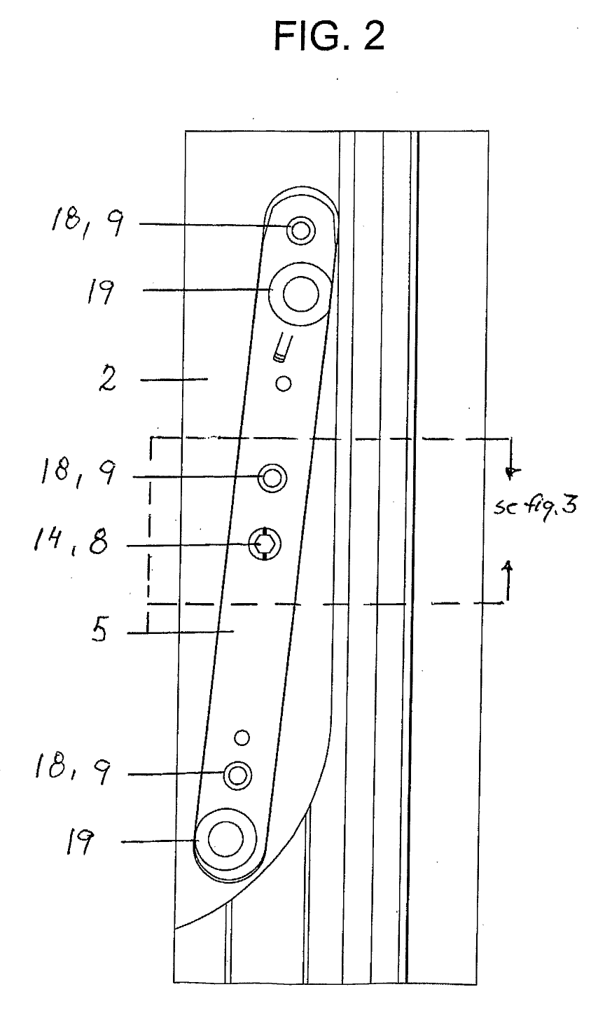

FIG. 2 the mounting—called the fastening plate—in a mounted position in the window frame;

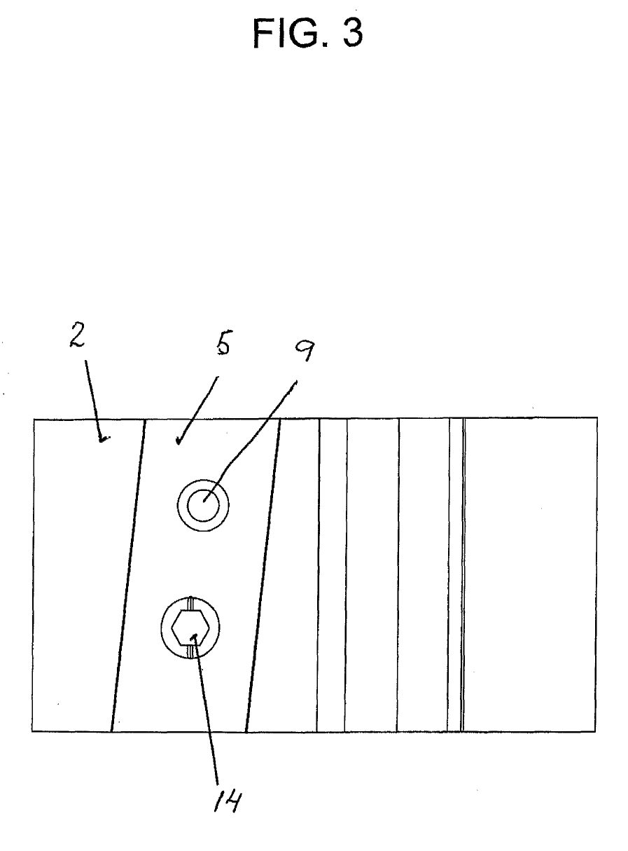

FIG. 3 a sectional view through the window frame and the fastening plate;

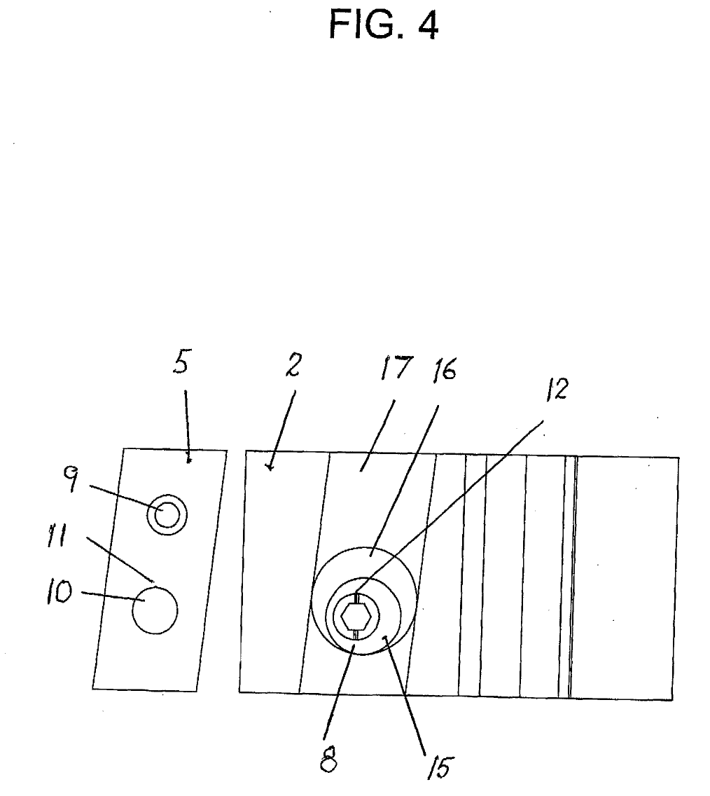

FIG. 4 the principal position of the eccentric in the window frame, the fastening plate having been removed;

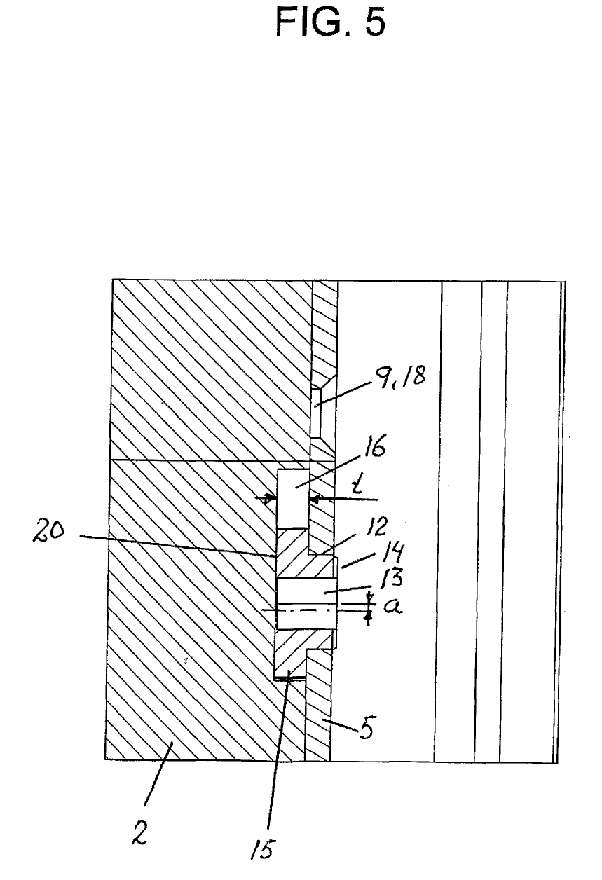

FIG. 5 a sectional view of the eccentric, recessed in the window frame and without the fastening plate.

In the drawings the same or similar parts are represented by the same reference numerals.

Thus, in FIG. 1 a window, a shutter or the like 1 is shown in its entirety, including a window frame 2, in which by a swinging arm mounting 3 a window casement 4 is swingingly mounted. Swinging arm mounting 3 is via swinging arms 6 and 7 fastened to fastening plate 5.

FIG. 2 shows fastening plate 5, which holds or carries window casement 4 against window frame 2. Fastening plate 5 is fastened against window frame 2 with screws, which are mounted in hole 9 with fixing screw 18—in this case three holes in plate 5 are shown—and in case the hole dimension of hole 9 permits a certain displacement of the plate upwards, a screw 18 with a suitable smaller diameter compared to the diameter of hole 9 will be chosen. The main function of these screws 18 is to fasten/fix in a position fastening plate 5 against window frame 2, regardless of whether an eccentric 8 will be used in the present case or not. Thus, screws 18 are completely connected to the fastening of the fastening plate and consequently they do not involve any additional costs or extra accessories in those cases, where an eccentric according to the present invention is to be used.

An extra hole 10 is made in fastening plate 5 to make it possible to mount eccentric 8. A mounting of eccentric 8 can be done at any time. Thus, the eccentric can be mounted in a factory, in which the mountings are made, by the window manufacturer or by the final customer, when the window is mounted on the building site.

FIG. 2 shows an eccentric 8, fitted into the fastening plate. Only eccentric pin 14 comes out from/through the fastening plate, whereas round disk 15 of the eccentric is positioned behind the fastening plate and is pressed by it against window frame 2, which is also shown in FIGS. 3-5. Eccentric 8 preferably is made of some form of a suitable plastic material, e.g. a glass fiber-reinforced thermoplastic resin, or some form of a suitably cast Al or brass alloy.

FIG. 3 shows in a sectional view window frame 2 and fastening plate 5 respectively. In this figure also one of holes 9 is shown, for fixing the fastening plate with fixing screw 18, as well as the projecting eccentric pin 14.

FIG. 4 shows a position, in which the fastening plate has been “lifted” away from its intended position. Window frame 2 has a milled-out portion 17 with a suitable width and depth allowing fastening plate 5 to be introduced into window frame 2. Also, a cylindrical space 16 has been made, suitably using a milling operation. The diameter of this cylindrical space 16 may be the same as or somewhat smaller than the width of milled-out portion 17. Since cylindrical space 16 has the same diameter as the width of milled-out portion 17, it is possible to carry out these two milling operations with the same tool and this milling operation does not require any modern, expensive CNC-guided manufacturing machine, but it can be carried out by conventional machines. The diameter of recess 16 is larger than the diameter of disk 15 of the eccentric to allow the eccentric to be rotated without a lateral displacement of the fastening plate, only vertically. However, the differences in diameter between eccentric disk 15 and milled-out portion 16 must be large enough to allow the angle between the tangent for the point, where the load is picked up, and the horizontal plane be as small as possible, in order to reduce the lateral forces during the adjustment. To mount eccentric 8, in a simple way into the right position, i.e. in a position, where the center of eccentric pin 14 and the center of disk 15 are positioned along the same line and at right angles to the longitudinal axis of the fastening plate, which means, that the center of pin 14 will be positioned at the same height as the center of disk 15 seen in the longitudinal direction of fastening plate 5, hole 10 for eccentric pin 14 suitably may be provided with a small recess 11. Against this recess the eccentric pin may e.g. be provided with a pin 12. As an alternative to this design the envelope surface of the eccentric pin may be provided with bars or grooves in order to obtain a suitable torque, or a torsion resistance, when the eccentric is adjusted. Thus, by designing the surface of pin 14 and the dimension of hole 10 in a suitable way a suitable friction between these two parts can be obtained. However, this design must guarantee or make it possible to always obtain the right mounting position of the eccentric in relation to fastening plate 5. With this design or equivalent designs of the hole and the pin it will be possible to mount the eccentric in relation to the fastening plate in alternative scenarios and consequently a mounting of the eccentric may be carried out alternatively in a factory, by e.g. the window manufacturer or by a final customer at a later occasion.

FIG. 5 shows a section through window frame 2 and shows the principal position of the eccentric in relation to the window frame.

In order to obtain a reliable function of the mounting of the eccentric the thickness of disk 15 must be so large, that the weight of the complete casement/window 4 can be received by the material in window frame 2 in a way, which ensures safety. One estimate is, that the thickness of disk 15 will lie in the interval from 3 to 8 mm, suitably 6 mm. To the self-weight of the window casement/window will be added those forces, which result, when the window casement will be height-adjusted via the eccentric. This must be taken into consideration, when the forces, with which eccentric 8 influences window frame 2, are to be calculated. The eccentricity between pin 14 and disk 15 has been indicated by “a” in the figure. One value of this measurement is 1-3 mm and suitably about 1.7 mm. By making the milled-out portion 16 somewhat less deep—measurement “t” in FIG. 5—than the thickness of round disk 15 of the eccentric—a difference of about 0.3 mm is a suitable measurement—it will be possible to fasten the eccentric between fastening plate 5 and window frame 2 in connection with the mounting of fixing screws 18 in holes 9. In this mounted position the eccentric is completely locked in its position. In case it would be desirable to be able to adjust the height of the fastening plate, fixing screws 18 are to be loosened about a half turn and the eccentric is to be turned by a socked head cap screw key. The end surface of the eccentric pin is provided with a socket head cap screw receiving portion 13. The outer cylindrical portion of the eccentric pin is also somewhat cone-shaped in order to be able to more easily mount the eccentric on the fastening plate. When the eccentric with the socket head cap key is turned, pin 12 is broken off. The function of the pin was of course only to determine the position of eccentric 8 in relation to fastening plate 5. When fixing screws 18 have been loosened about half a turn, the eccentric will be turned to obtain the right height position. Then the fastening screws will be tightened again and then the eccentric has been locked in its new position. By providing rear end surface 20 of the eccentric in a suitable way with a position-retaining pattern, e.g. a cross-like groove, a reinforcement of the final mounting position of the eccentric will be obtained, in connection with the definitive tightening of fastening screws 18 into their final position.

1. A device for height adjustment of a window (1) in connection with or subsequent to a mounting of it in a window frame (2), the adjustment mechanism, an eccentric (8) being positioned between a fastening plate (5), which supports a window casement (4), and a recess (17), made in the window frame (2), characterized in that said eccentric (8) is provided with an eccentric pin (14), which is provided with a pin (12), which is designed to be able to fix the eccentric in its right/desired position in relation to the fastening plate (5) and which cooperates with a hole (10) in the fastening plate (5), and in that the eccentric (8) alternatively is mounted on the fastening plate (5) in connection with the manufacture of those two details in a factory or is mounted by the window manufacturer or by the final customer in a later stage.

2. A device according to claim 1, characterized in that the eccentric (8) in its final mounting position is fastened between the fastening plate (5) and the window frame (2) by means of the fixing screws (18).

3. A device according to claim 1, characterized in that the eccentric pin (14) is provided with bars or grooves, which with a press fit are coordinated concerning dimensions with said hole (10) in the fastening plate (5) in order to obtain a suitable torque or a torsion resistance, when the position of the eccentric is adjusted, as well as in that the eccentric pin (14) in its end surface is provided with a key grip, preferably a socket head cap key grip (13).
